(19) United States
(12) Patent Application Publication
(10) Pub. No.: US 2017/0011498 A1
(43) Pub. Date: Jan. 12, 2017

(54) SYSTEM, METHOD AND APPARATUS FOR CONFIRMING FIXTURE/DISPLAY ASSEMBLY AND/OR COMPLIANCE

(71) Applicant: DCI Marketing, Inc., Milwaukee, WI (US)

(72) Inventors: Ben S. Yu, Mequon, WI (US); Samrat Saha, Dousman, WI (US)

(21) Appl. No.: 15/202,329

(22) Filed: Jul. 5, 2016

Related U.S. Application Data
(60) Provisional application No. 62/288,276, filed on Jan. 28, 2016.
(60) Provisional application No. 62/189,521, filed on Jul. 7, 2015.

(51) Int. Cl. G06T 7/00

(52) U.S. Cl. CPC G06T 7/001; G06T 2207/30164

(57) ABSTRACT

Disclosed herein are systems, methods and apparatus for confirming fixture/display assembly and/or compliance. In some forms, systems, methods, and apparatus are disclosed for assessing the accuracy of fixture and display assemblies or setups and/or confirming compliance of fixtures and displays at specific periods of time. In still other forms, thin or thick client systems, methods and apparatus are disclosed. For example, in one form, a method comprises: receiving, at a mobile computing device, an indicium of a fixture; receiving, at the mobile computing device, fixture data based on the indicium of the fixture; presenting, via a display device of the mobile computing device, a graphical representation of the fixture data; capturing, via an image capture device of the mobile device, an image of the fixture; and determining, based on the image of the fixture and the fixture data, compliance of the fixture.

### CROSS-REFERENCE To RELATED APPLICATIONS

This application claims the benefit of U.S. Provisional Application No. 62/189,521, filed Jul. 7, 2015, and U.S. Provisional Application No. 62/288,276, filed Jan. 28, 2016, both of which are incorporated herein by reference in their entirety.

### FIELD OF THE INVENTION

This invention relates generally to fixture display assembly and compliance and, more particularly, to systems, methods, and apparatuses for assessing the accuracy of fixture and display assemblies or setups and/or confirming compliance of fixtures and displays at specific periods of time.

### BACKGROUND OF THE INVENTION

Most retailers and/or product manufacturers who sell products through retail establishments utilize fixtures and product displays to sell their goods. These parties also pay people to set up (e.g., assemble, configure, build, etc.) these fixtures and displays and to maintain the fixtures, displays and displayed product once set up. Many of these displays and fixtures can be difficult to set up and attempts have been made to make setup easier (e.g., planograms, color-coding, etc.). Unfortunately, there are no good solutions for these parties to use to determine or assess if a fixture or display is set up accurately and/or to confirm compliance with specified instructions for such fixtures and displays, such as whether they are presented or removed by a particular time (e.g., date, time, season, etc.), whether the fixtures and displays are being maintained as they should be so that product is properly displayed, whether they are in the correct location, whether they are being stocked appropriately and/or as desired by personnel tasked with such duties, etc. These parties also do not have resources available to them to determine who to hire for the jobs of assembling and maintaining such fixtures and displays and/or resources that help them grade or evaluate the performance of these hired people. Similarly, these parties do not have resources available to them to evaluate whether personnel tasked with keeping the fixtures or displays stocked with product are doing a good job.

Accordingly, it has been determined that a need exists for improved systems, methods and apparatus for addressing these shortcomings.

### BRIEF DESCRIPTION OF THE DRAWINGS

Described herein are embodiments of systems, methods, and apparatuses for addressing these shortcomings.

FIG. 1A depicts usage of a mobile device 102 to perform a compliance check of a fixture 106, according to some embodiments of the inventive subject matter.

FIG. 1B illustrates how the mobile device 102 is used to confirm compliance of fixture 106, according to some embodiments of the inventive subject matter.

FIG. 1C illustrates how the mobile device 102 is used to confirm non-compliance of the fixture 106, according to some embodiments of the inventive subject matter.

FIG. 2 is a block diagram depicting a thin client embodiment of a system for conducting compliance checks, according to some embodiments of the inventive subject matter.

FIG. 3 is a flow diagram depicting example operations of a thin client embodiment for performing compliance checks from the perspective of a mobile device.

FIG. 4 is a flow diagram depicting example operations of a thin client embodiment for performing compliance checks from the perspective of a compliance data server.

FIG. 5 is a block diagram depicting a thick client example of a system for conducting compliance checks, according to some embodiments of the inventive subject matter.

FIG. 6 is a flow diagram depicting example operations of a thick client embodiment for performing compliance checks from the perspective of a mobile device.

FIG. 7 is a flow diagram depicting example operations of a thick client embodiment for performing compliance checks from the perspective of a compliance data server.

FIG. 8A depicts usage of a mobile device 830 to perform a compliance check, according to some embodiments of the inventive subject matter.

FIGS. 8B-8C depict products 828 located on a shelving unit 820, the compliance of which can be checked based on features of the shelving unit 820, according to some embodiments of the inventive subject matter.

FIG. 9 depicts a pallet-type display 938 upon which compliance checks can be performed, according to some embodiments of the inventive subject matter.

FIGS. 10A-C depict an alternate a display 1052 that is supported by a shelving unit 1050 upon which compliance checks can be performed, according to some embodiments of the inventive subject matter, with FIG. 10A illustrating a perspective view, FIG. 10C illustrating an enlarged and exploded view and FIG. 10B illustrating a side elevation view, respectively.

FIG. 11 is a flow chart depicting example operations for tracking compliance information for assemblers, according to some embodiments of the inventive subject matter.

FIG. 12 is a flow chart depicting example operations for tracking feedback information for assemblers, according to some embodiments of the inventive subject matter.

FIG. 13 is a flow chart depicting example operations for providing a list of assemblers in response to a request, according to some embodiments of the inventive subject matter.

FIG. 14 is a flow chart depicting example operations for tracking entity stocking information.

FIGS. 15A-15C depict an example of providing step-by-step directions for fixture assembly, according to some embodiments of the inventive subject matter.

FIG. 16 depicts usage of one or more sensors to determine compliance of a fixture 1576, according to some embodiments of the inventive subject matter.

### DETAILED DESCRIPTION

Various systems, methods, and apparatuses are contemplated for determining compliance of a fixture, or product presentation, using the concepts disclosed herein. For example, systems, methods, and apparatuses are disclosed for determining, or aiding in a determination, that a fixture is, or has been, properly assembled, products are, or have been, properly presented on a shelf or other display, a fixture or display is, or has been, properly located within a retail establishment, etc. Such compliance checks can be performed using a mobile device, dedicated image capture devices, image capture devices integrated in a retail establishment, etc. Information relating to the compliance checks can be logged and analyzed with regard to a specific fixture, a type of fixtures, a display, a retail establishment, an entity or assembler of fixtures, and an entity responsible for stocking or preparing a display. Data analysis can be performed on the logged data and used in many ways (e.g., data may be used to determine if the fixture installer has installed the fixture correctly, determine how efficient and/or accurate the fixture installer is at installing fixtures, determine how well personnel, such as direct-store-delivery (DSD) personnel, are at keeping the fixture stocked and looking the way the product supplier and/or retailer want it to look, etc.).

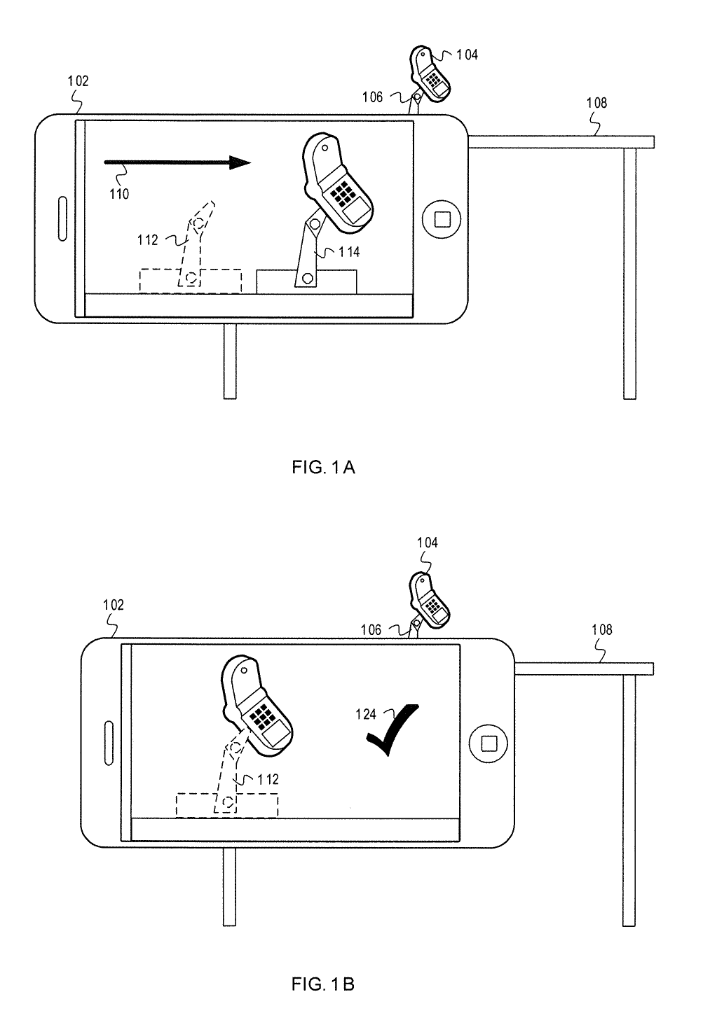

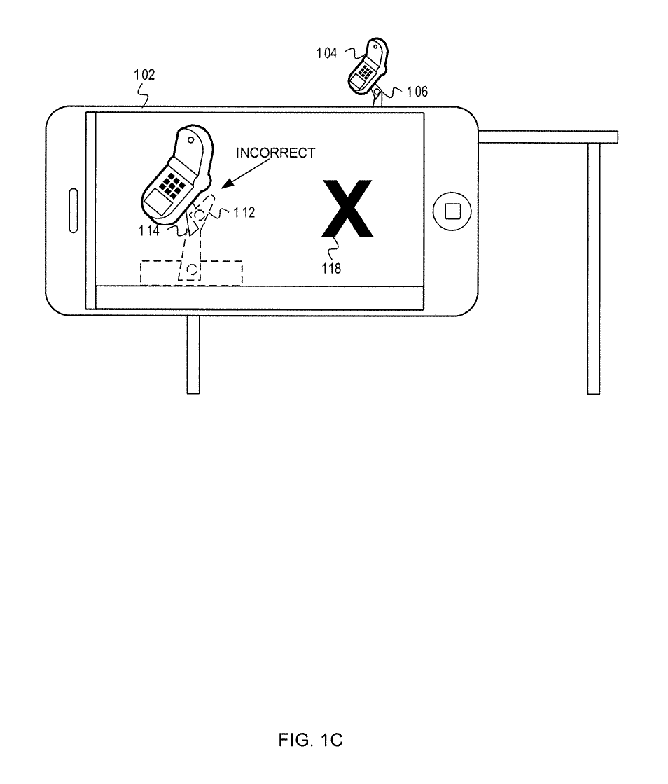

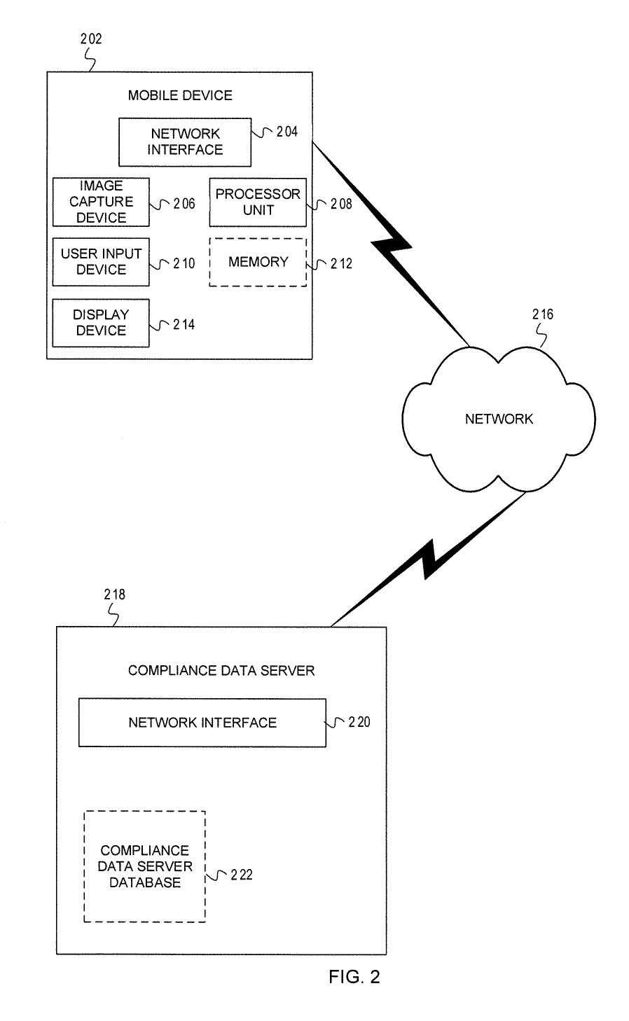

FIG. 1A depicts usage of a mobile device 102 to perform a compliance check of a fixture 106, according to some embodiments of the inventive subject matter. In FIG. 1A, the mobile device 102 captures an image 114 of a fixture 106 supporting a product 104 located on a display, such as a table 108. The mobile device 102 presents the image 114 on its display device. The mobile device 102 also presents a graphical representation 112 of the fixture 106 and an arrow 110 indicating that the user should align the graphical representation 112 with the image 114 of the fixture 106 on the mobile device's 102 display device. In a preferred form, the graphical representation 112 is a depiction of what the fixture 106 should look like when properly assembled. The graphical representation 112 can include a picture of the fixture, 106, a drawing of the fixture 106, a computer generated image of the fixture 106, a dotted or dashed outline of the fixture 106, a partially shaded outline of the fixture 106, an outline of the fixture 106, or any other suitable indicia of a properly assembled fixture. As depicted in FIG. 1A, the graphical representation 112 is a dashed outline of the fixture 106.

FIG. 1B depicts usage of a mobile device 118 to perform a compliance check of a fixture 106, according to some embodiments of the inventive subject matter. In FIG. 1B, the user has aligned the graphical representation 112 with the image of the fixture 106 on the mobile device's 118 display device. As can be seen, the graphical representation 112 matches the fixture 106. Because the graphical representation 112 and the fixture 106 match, it can be determined that the fixture 106 has been assembled properly. In some embodiments, the user makes this determination by visually comparing the graphical representation 106 with an image of the fixture 106 presented on the mobile device's 118 display device. In such embodiments, the user can indicate that the fixture 106 is properly assembled by pressing a button on the mobile device 118. The mobile device 118 can then store this indication and/or transmit this indication to a backend server. In other embodiments, either the mobile device 118 or a backend server can make this determination. In such embodiments, the mobile device 118 can present an indication that the fixture 106 is assembled correctly to the user, such as, for example, an indicia of approval or compliance such as checkmark 124.

In some embodiments, the user can capture a still image of the fixture and the still image is compared to the graphical representation. In such embodiments, the graphical representation may only be used to aid in positioning the mobile device in such a manner as to capture an image of the fixture from the proper vantage point. For example, the mobile device can present the graphical representation while the user positions the mobile device so that the fixture falls within the graphical representation. Alternatively, the mobile device may not present the graphical representation at all. In other embodiments, the comparison may be performed in an augmented reality type fashion. In such embodiments, the graphical representation can appear to be three-dimensional in that as that the user positions that mobile device about the fixture, the graphical representation can rotate or move to match the orientation of the fixture relative to the mobile device.

In some embodiments, such mobile-based compliance checks can be performed by employees of a retailer, display manufacturer, independent company, etc. In addition to, or in lieu of, employees performing such checks, in some forms consumers can perform such compliance checks. In such embodiments, manufacturers, retailers, etc. can provide incentives for consumers to perform such compliance checks. For example, a manufacturer can provide coupons to customers in return for performing compliance checks. Additionally, such performance checks can be gamified. For example, a manufacturer or maker of displays may create a game in which consumers must complete specific tasks. Upon completion, the consumers are awarded with virtual currency, real currency, tangible prizes, intangible prizes, etc.

Although not shown in FIGS. 1A-1B, in some embodiments, the graphical representation can include, in addition to an outline (or any other indicium) of the fixture, an outline of a shelf or display upon which the fixture is supposed to be located. In such embodiments, not only can proper assembly of the fixture be determined, but also that the fixture is positioned correctly upon the shelf or display. Further, in some embodiments, the outline (or any other indicium) of the fixture can include an outline of the product associated with the fixture. In such embodiments, not only can proper assembly of the fixture be determined, but also that the correct product is supported by or attached to the fixture or that the product is properly positioned on the fixture. In yet other forms, an outline of the fixture, shelving, display, etc. may be illustrated along with surrounding area so that the location within the retail store can be checked and confirmed (e.g., are these items located in an end unit as indicated because of the surrounding floor illustrated, are the items displayed properly mid-shelf in a shelf-less location between adjacent shelving units as indicated because of the surrounding shelving locations or positions, etc.). Examples of the latter issues will be discussed further later on in this application.

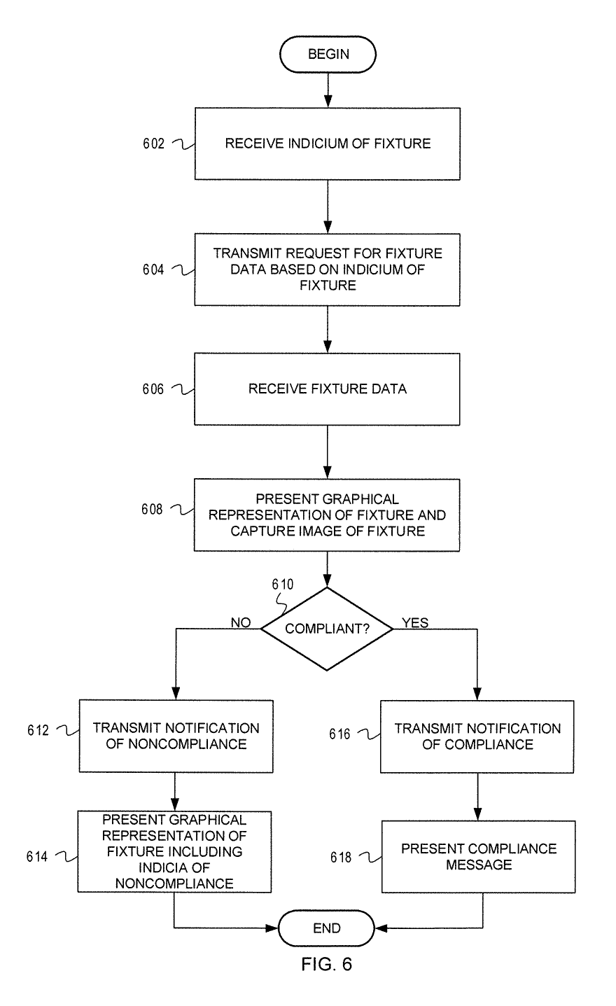

For purposes of convenience, items that are similar to those discussed throughout this application will be referenced by using the same two-digit number but using a preceding digit(s) corresponding to the figure number (with the exception of flow charts) to simply distinguish from one another. For example, in FIG. 1, the mobile device is referred to by the reference numeral 102 while the mobile device is referred to by the reference numeral 502 in FIG. 5.

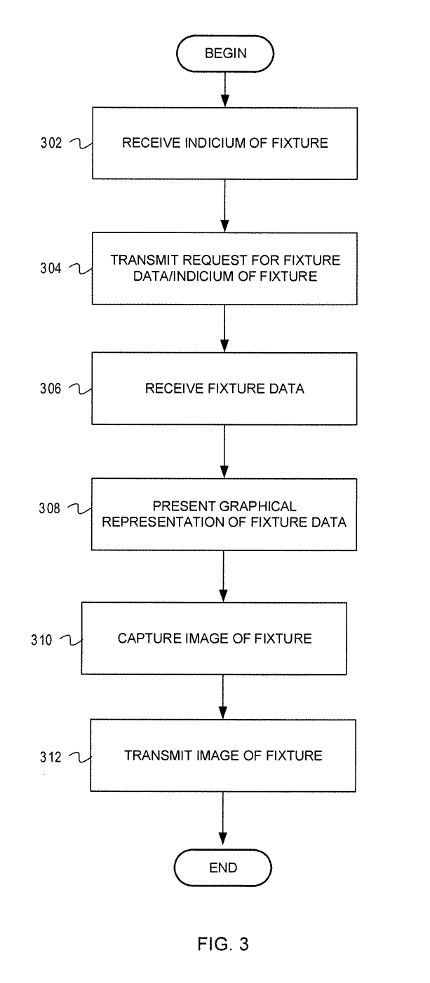

FIG. 2 depicts usage of a mobile device 102 to perform a compliance check of a fixture 106, according to some embodiments of the inventive subject matter. As with FIGS. 1A-1B, a mobile device 102 presents an image 114 of a fixture 106 captured by the mobile device 102. The mobile device 102 also presents a graphical representation 210 of the fixture 206 in a properly assembled state. The fixture 106 has not been assembled properly, as shown by the discrepancy between the graphical representation 210 and the image 114. In some embodiments, the user determines that the fixture 106 has been assembled improperly and indicates that the fixture 106 has been assembled improperly by selecting a button on the mobile device. In other embodiments, the mobile device (or a backend server) makes this determination and the mobile device presents an indication of the determination, such as an indicia of disapproval or non-compliance such as an “X” 118 presented by the mobile device 102 in FIG. 2.

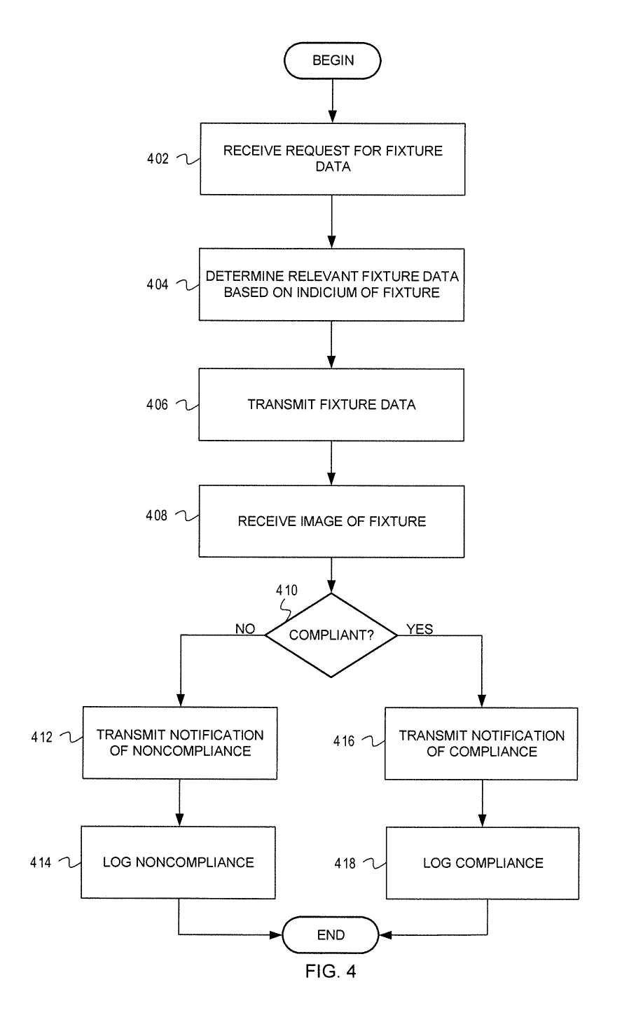

While FIGS. 1A, 1B, and 1C and the associated text provide an overview of one embodiment of the inventive subject matter, FIGS. 3-5 and the associated text provide further detail about a thin client embodiment of the inventive subject matter in which a compliance data server determines whether the fixture is compliant.

FIG. 2 is a block diagram depicting a thin client embodiment of a system for conducting compliance checks, according to some embodiments of the inventive subject matter. As previously discussed, in some embodiments, a mobile device or backend server can determine compliance of a fixture or display. In the thin client embodiment, the backend server determines compliance of the fixture or display. In the example depicted in FIG. 2, the backend server is a compliance data server 218. In addition to the backend server 218, the system comprises a network 216 and a mobile device 202. The network 216 can be any suitable wired and/or wireless network (e.g., the Internet or an intranet). The mobile device 202 includes a network interface 204, an image capture device 206, a processor unit 208, a user input device 210, optional onboard memory 212, and a display device 214. The network interface 204 can be any suitable hardware and/or software that allows the mobile device 202 to communicate via the network 216. The mobile device 202 presents the graphical representation of the fixture (where applicable) on its display device 214 and captures an image of the fixture using its image capture device.

After capturing the image of the fixture, the mobile device 202 transmits the image of the fixture, via the network 216, to the compliance data server 218. The compliance data server 218 includes a network interface 220 which allows the compliance data server 218 to communicate via the network 216. After receiving the image of the fixture, the compliance data server 218 determines compliance of the fixture (e.g., whether the fixture is assembled properly, positioned properly within a larger display, etc.). The compliance data server 218 can determine compliance using any suitable technique (e.g., image analysis). In some embodiments, the compliance data server 218 also includes a compliance data server database 222. The compliance data server database 222 can store information regarding compliance ratings for one or more assemblers of fixtures and/or entities responsible for stocking or preparing displays. However, in some embodiments, the compliance data server database 222 may not reside within the compliance data server 218. Rather, the compliance data server 222 may be a separate hardware element from the compliance data server 218. In such embodiments, the compliance data server 218 can transmit the information regarding compliance ratings to the compliance data server database 222.

FIG. 3 is a flow diagram depicting example operations of a thin client embodiment for performing compliance checks from the perspective of a mobile device. The flow beings at block 302.

At block 302, the mobile device receives an indicium of the fixture. The indicium of the fixture can be used by a backed server or other device to identify the fixture (e.g., a compliance data server). For example, a user can scan or otherwise capture an image of a visual indicium, such as a two- or three-dimensional barcode, an alphabetic, numeric, or alphabetic code, a pictorial identifier, etc. Alternatively, the mobile device can detect and receive the indicium by non-visual means such as auditory means or data transmission means, such as Bluetooth, NFC, etc. In other embodiments, the user can provide the indicium, such as by entering a code or number associated with the fixture or by selecting the fixture from a menu. Finally, in some embodiments, the indicium of the fixture may simply by an image of the fixture. In such embodiments the backend server or other device can identify the fixture based on an image of the fixture. The flow continues at block 304.

At block 304, the mobile device transmits a request for fixture data to the compliance data server. In some embodiments, the request for fixture data can include the indicium of the fixture. Such transmission can take any suitable form, both wired and/or wireless using any suitable communication protocol. The flow continues at block 306.

At block 306, the mobile device receives fixture data from the compliance data server. In some embodiments, the fixture data can include a graphical representation of the fixture, such as a graphic of the fixture comprising a dashed or dotted line, an outline of the fixture, a shaded graphic of the fixture, etc. The flow continues at block 308.

At block 308, the mobile device presents the graphical representation of the fixture. As previously discussed, in some embodiments, the mobile device may not present a graphical representation of the fixture. In such embodiments, the operations of block 306 and block 308 may not be necessary. The flow continues at block 310.

At block 310, the mobile device captures an image of the fixture. In some embodiments, the image of the fixture includes only the fixture. In other embodiments, the image of the fixture comprises a generated image including not only the fixture but also the graphical representation of the fixture, for example, superimposed over the fixture. The flow continues at block 312.

At block 312, the mobile device transmits the image of the fixture to the compliance data server.

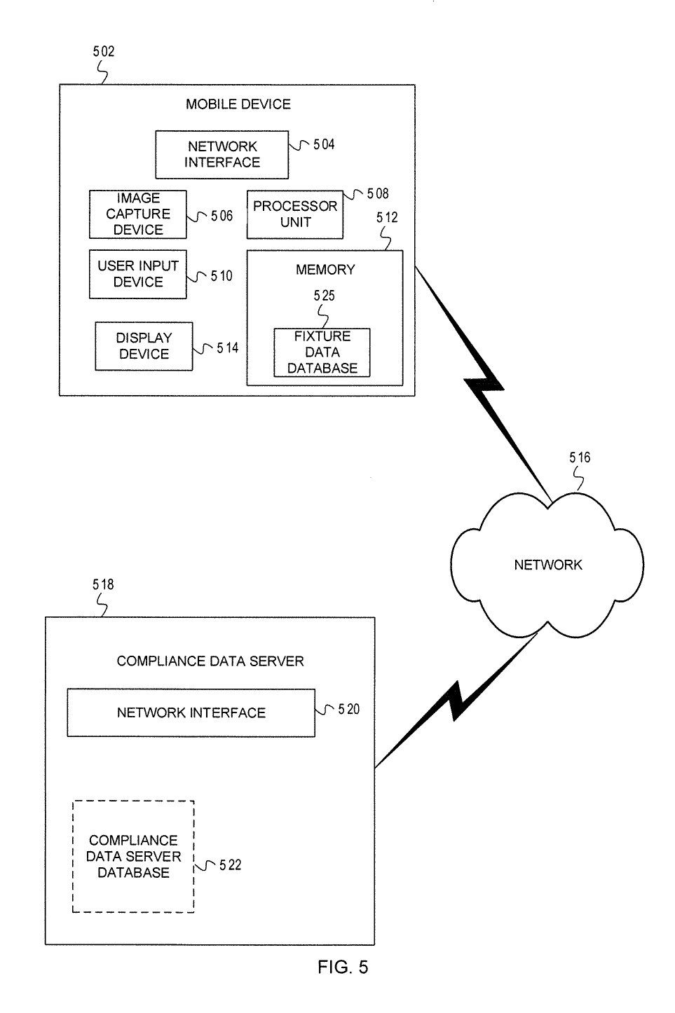

FIG. 4 is a flow diagram depicting example operations of a thin client embodiment for performing compliance checks from the perspective of a compliance data server. The flow begins at block 402.

At block 402, the compliance data server receives a request for fixture data from a mobile device. In some embodiments, the request for fixture data can include an indicium of the fixture. The flow continues at block 404.

At block 404, the compliance data server determines fixture data based on the request for fixture data and/or the indicium of the fixture. For example, the compliance data server can search a database, or other type of data repository, using the indicium of the fixture. The flow continues at block 406.

At block 406, the compliance data server transmits the fixture data to the mobile device. The flow continues at block 408.

At block 408, the compliance data server receives an image of the fixture from the mobile device. As previously discussed, the image of the fixture can include only the fixture, the fixture and surrounding objects, and/or a graphical representation of the fixture superimposed or otherwise included with the fixture. The flow continues at decision diamond 410.

At decision diamond 410, the compliance data server determines whether the fixture is compliant. The fixture data server can use any suitable image comparison techniques to determine whether the fixture is compliant. For example, the compliance data server can compare an outline of the fixture (based on the image of the fixture) with either the graphical representation of the fixture or an image of a correctly assembled fixture. Additionally, the compliance data server can calculate distances between components of the image of the fixture and compare those measurements to known or calculated measurements associated with a properly assembled fixture. Additionally, in some embodiments, before determining whether the fixture is compliant, the compliance data server first determines an orientation of the fixture from the image of the fixture. For example, the image of the fixture may have been taken from the left of the fixture, the right of the fixture, in front of the fixture, behind the fixture, in front of the fixture, below the fixture, or any combination of the above-noted orientations. In such embodiments the data compliance server may be able to determine whether the fixture is compliant regardless of the orientation of the fixture in the image. Additionally, in some embodiments, the compliance data server can determine if the correct product is displayed by the fixture, the product displayed by the fixture is oriented properly, etc. If the compliance data server determines that the figure is compliant, the flow continues at block 416.

At block 416, the compliance data server transmits a notification of compliance to the mobile device. This operation may not occur in all embodiments. Additionally, in some embodiments, the compliance data server can transmit such a notification to other device and/or parties, such as the retail establishment where the fixture is located, a company associated with the fixture, a company associated with the product displayed by the fixture, etc. The flow continues at block 418.

At block 418, the compliance data server logs the compliance. For example, the compliance data server can record an indication in a database that the fixture was assembled properly. This indication can include other information such as a time that the image of the fixture was taken and/or comparison was performed, a location that the image of the fixture was taken, etc. The compliance data server can log this information locally and/or transmit the information for storage remote from the compliance data server.

If the compliance data server determines that the fixture is not complaint at block 510, the flow continues at block 412.

At block 412, the compliance data server transmits a notification of noncompliance. This operation may not occur in all embodiments. Additionally, in some embodiments, the compliance data server can transmit such a notification to other device and/or parties, such as the retail establishment where the fixture is located, a company associated with the fixture, a company associated with the product displayed by the fixture, etc. The flow continues at block 414.

At block 414, the compliance data server logs the noncompliance. For example, the compliance data server can record an indication in a database that the fixture was not assembled properly. This indication can include other information such as a time that the image of the fixture was taken and/or comparison was performed, a location that the image of the fixture was taken, etc. The compliance data server can log this information locally and/or transmit the information for storage remote from the compliance data server.

While separate thin or thick client versions have been discussed herein, it should be understood that in alternate embodiments systems, methods and apparatuses are provided that could be a combination of both so that on projects in urban areas with ample network connectivity, the thin client version could be used and in other more rural areas or areas without sufficient network connectivity, the thick client version could be used to reduce the amount of data transmission required to complete the compliance analysis or check. In addition, although specific features have been discussed herein, it should be understood that in alternate embodiments more or fewer features may be utilized as needed. For example, in some forms, the systems, methods and apparatus utilize cloud-based configurations that allow certain features to not be included on the mobile device or central computer system. For example, while some forms above illustrate onboard memory and databases, these could be replaced with cloud-based counterparts. Similarly, while separate memory and database items are shown, it should be understood that the database may be stored on this memory and, thus, this feature may be one and the same. In yet other embodiments the features of the above embodiments may be mixed and matched to come up with yet other embodiments with fewer or more features, etc.

While FIGS. 2-4 and the associated text provide further detail about a thin client embodiment of the inventive subject matter, FIGS. 5-7 and the associated text provide further details about a thick client embodiment of the inventive subject matter in which the mobile device determines whether the fixture is compliant.

FIG. 5 is a block diagram depicting a thick client example of a system for conducting compliance checks, according to some embodiments of the inventive subject matter. The system of FIG. 5 includes a mobile device 502, a network 516, and a compliance data server 518. The mobile device 502 includes a network interface 504, an image capture device 506, a processor unit 508, a user input device 510, memory 512, a fixture data database 525, and a display device 514. The mobile device 502 receives an indicium of a fixture and, utilizing the fixture data database 525, determines fixture data for the fixture. In some embodiments, the mobile device 502 presents a graphical representation of the fixture, based on the fixture data, on its display device 514. The mobile device 502 captures, via the image capture device 506, an image of the fixture. Using its processor unit 508, the mobile device 502 determines whether the fixture is compliant. After determining compliance of the fixture, the mobile device 502 transmits, via the network 516, compliance information to the compliance data server 518. The compliance data server 516 receives the compliance information via its network interface 520 and records the compliance information in a compliance data server database 522. The compliance data server database 522 may or may not reside on or within the compliance data server 518.

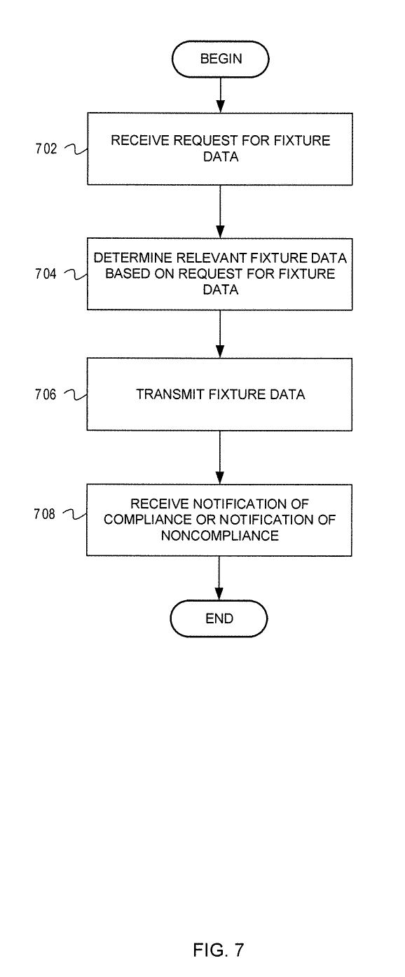

FIG. 6 is a flow diagram depicting example operations of a thick client embodiment for performing compliance checks from the perspective of a mobile device. The flow beings at block 602.

At block 602, a mobile device receives an indicium of the fixture. The indicium of the fixture identifies the fixture. The indicium of the fixture can be a visual indicium, auditory indicium, data transmission indicium, or any other suitable indicium. Additionally, in some embodiments, the indicium may be user input received on the mobile device, such as user selection of the fixture from a list or menu. The flow continues at block 604.

At block 604, the mobile device transmits a request for fixture data based on the indicium of the fixture. In some embodiments, the mobile device may transmit such a request to a backend server, such as a compliance data server. In other embodiments, this “transmission” can be local to the mobile device. For example, in embodiments in which the mobile device includes a fixture data database, the mobile device can request, from the fixture data database, an entry associated with the indicium of the fixture. The flow continues at block 606.

At block 606, the mobile device receives the fixture data. In embodiments in which the mobile device transmits the request for fixture data to a data compliance server, the mobile device receives the fixture data from the data compliance server. In embodiments in which the mobile device stores the fixture data locally, the mobile device may receive the fixture data from its own local memory. In one form, the fixture data includes a graphical representation of the fixture. In other forms, the fixture data may comprise only data necessary for the mobile device (or any other device) to determine if the fixture is compliant (e.g., measurements). The flow continues at block 608.

At block 608, the mobile device presents the graphical representation of the fixture and captures an image of the fixture. In some embodiments, the mobile device presents the graphical representation of the fixture as a static image while the display device simultaneously presents a static or dynamic image of the field of view of the mobile device's image capture device. In other embodiments, the mobile device presents the graphical representation of the fixture as a dynamic two- or three-dimensional image. In such embodiments, the graphical representation of the fixture can move and/or rotate as the mobile device moves about the fixture. In one form, the mobile device captures an image of the fixture and stores that image to a permanent or semi-permanent memory. In other forms, a camera buffer, or other temporary storage, is accessed to acquire an image of the fixture. Additionally, the image of the fixture can include the fixture, the fixture and its surroundings (e.g., background, other products, other fixtures, etc.), and the fixture and the graphical representation of the fixture, or any combination of the aforementioned. The flow continues at decision diamond 610.

At decision diamond 610, the mobile device determines whether the fixture is compliant. Such determination can be performed using any suitable image comparison technique. If the fixture is compatible, the flow continues at block 616. If the fixture is not compatible, the flow continues at block 612.

At block 616, the mobile device transmits a notification of compliance to the compliance data server. Such notification can include the indicium of the fixture, the image of the fixture, a date and/or time the image was taken, a date and/or time the compliance determination was made, etc. In some embodiments, the mobile device can, in lieu of or in addition to transmitting the notification of compliance, store an indication of compliance locally. The flow continues at block 618.

At block 618, the mobile device present a compliance message.

As previously discussed, if the mobile device determines that the fixture is not compliant at decision diamond 610, the flow continues at block 612. At block 612, the mobile device transmits a notification of noncompliance to the compliance data server. Such notification can include the indicium of the fixture, the image of the fixture, a date and/or time the image was taken, a date and/or time the compliance determination was made, etc. In some embodiments, the mobile device can, in lieu of or in addition to transmitting the notification of noncompliance, store an indication of noncompliance locally. The flow continues at block 614.

At block 614, the mobile device presents the graphical representation of the fixture including an indicium of noncompliance. For example, the mobile device can present the image of the fixture superimposed with the graphical representation of the fixture and an arrow, or other indicator, alerting a user as to the reason for noncompliance. Alternatively, the mobile device can simply present a noncompliance message.

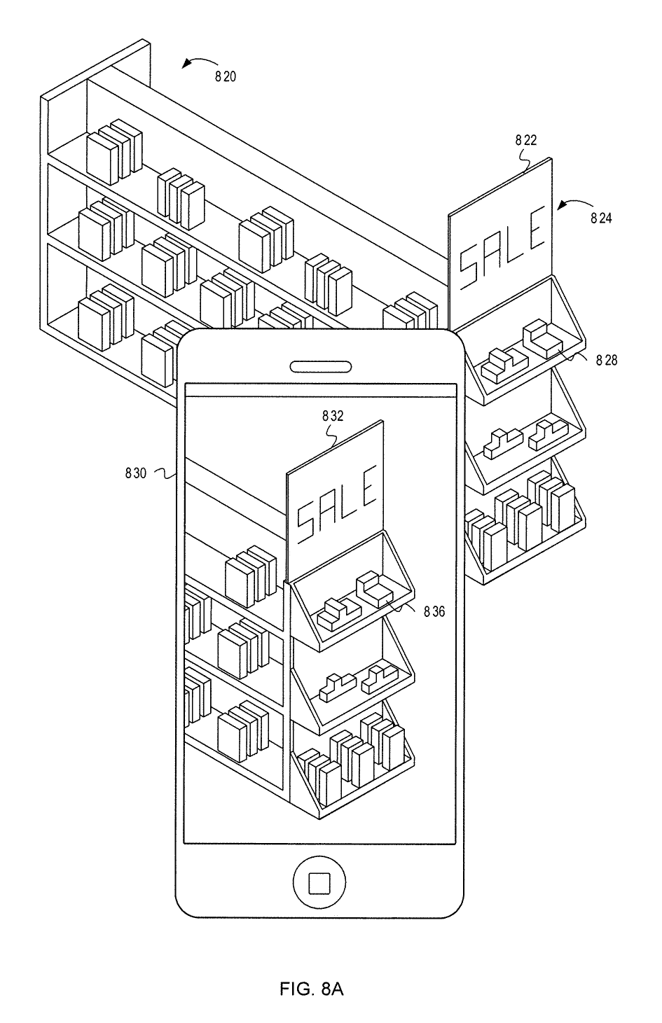

FIG. 7 is a flow diagram depicting example operations of a thick client embodiment for performing compliance checks from the perspective of a compliance data server. The flow begins at block 802.

At block 702, the compliance data server receives a request for fixture data from a mobile device. The request for fixture data can include an indicium of the fixture. The flow continues at block 704.

At block 704, the compliance data server determines relevant fixture data based on the request for fixture data. The flow continues at block 706.

At block 706, the compliance data server transmits the fixture data to the mobile device. It should be noted that, as described in the discussion of FIG. 6, in some embodiments the mobile device has access to fixture data locally. In such embodiments, the operations of blocks 702-706 may not be necessary. The flow continues at block 708.

At block 708 the compliance data server received a notification of compliance or a notification of noncompliance from the mobile device. Such notification can include the indicium of the fixture, the image of the fixture, the graphical representation of the fixture, a date and/or time that the image of the fixture was captured, and/or a date and/or time that the compliance was determined.

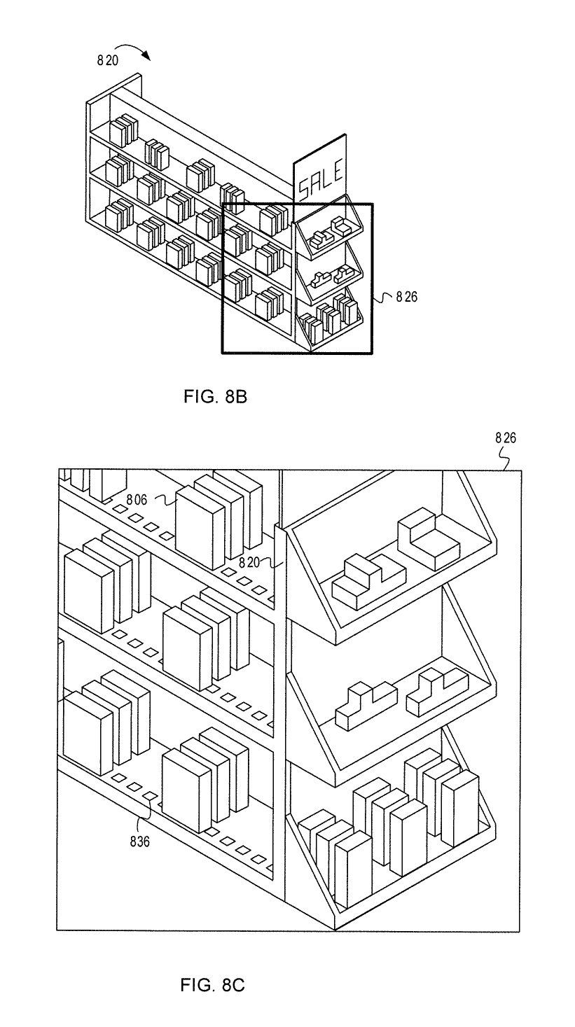

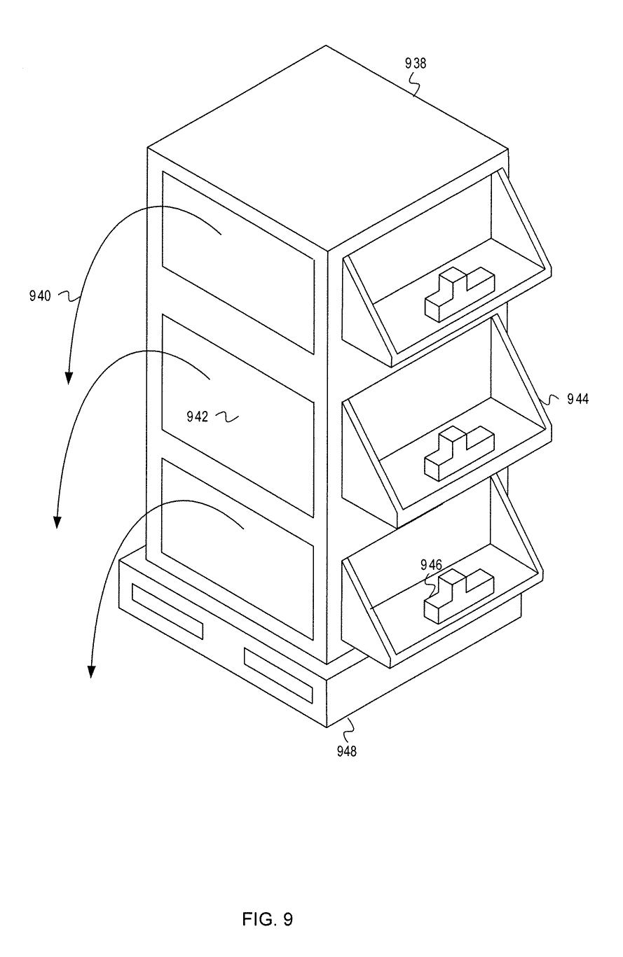

In addition to determining whether a fixture has been assembled correctly, embodiments of the inventive subject matter can be used to determine whether a product display has been arranged or located properly. FIGS. 8-10 and the associated text describe using embodiments of the inventive subject matter to determine and/or verify if/that a product display has been arranged and located properly. While the discussion of FIGS. 1-10 primarily refer to capturing images of fixtures and/or displays with a mobile device, similar objectives can be achieved using image capture devices (both still and video) that are dedicated devices and/or installed within a retail establishment or warehouse. For example, a dedicated camera network, such as a closed circuit television network, can be used, possibly in conjunction with one or more other computing devices, in lieu of a mobile device.

FIG. 8A depicts usage of a mobile device 830 to perform a compliance check, according to some embodiments of the inventive subject matter. FIG. 8 depicts a shelving unit 820 including an endcap 824. The compliance check includes confirming that the signage 822 is properly applied, located, and/or correct, determining that the display is on an end of the shelving unit 820 (i.e., endcap 824), and that products 828 in the display are properly located and/or are the right products. The compliance check can be performed by capturing an image of the shelving unit 820 with the mobile device and comparing the captured image to a representation, such as a photograph, planogram, drawing, computer generated image, etc., of the shelving unit 820. Additionally, the compliance check can be performed by analyzing features of the captured image independent of, or in addition to, a comparison with the representation. For example, a device, such as the mobile device 830 or any other device (e.g., a compliance data server) can determine that the display is on an endcap by analyzing each side of the display. Because there are no products, shelving, etc. adjacent to the display (i.e., on either side of the display), the device can determine that the display is on an endcap. Furthermore, the device can determine that the display is on a specific endcap (i.e., endcap 824) based on products surrounding the endcap 824, identifying markers on the endcap 824 (not shown), location information (e.g., GPS coordinates associated with the captured image of the display), etc.

Furthermore, the device can determine if the signage 822 included in the display is the correct signage for the display. For example, the device can compare the captured image to a representation of the display. Additionally, or alternatively, the device can compare the signage in the image 832 to the products in the image 834 to determine whether the products in the image 834 are expected to be paired with the signage in the image 832. The device can also make this determination based on location information associated with the captured image.

Finally, the device can determine if the products 828 included in the display are the correct products for the display. For example, the device can compare the captured image to a representation of the display. Additionally, or alternatively, the device can compare the products in the image 834 with the signage in the image 832 (and/or any other objects in the image) to determine that the products 828 included in the display are the correct products for the display. The device can also make this determination based on location information associated with the captured image.

FIGS. 8B-8C depict products 828 located on a shelving unit 820, the compliance of which can be checked based on features of the shelving unit 820, according to some embodiments of the inventive subject matter. Section 826 of the shelving unit 820 is depicted in 8 FIG. 8C, as indicated by section 826. The shelving unit displays products 828. The shelving unit includes apertures 836 (e.g., inserts for modifying shelving unit 820). The position of the products 828 relative to the apertures 836 can indicate whether placement of the products 836 on shelving unit 820 is correct. Although FIG. 8 refers to using apertures to make this determination, any suitable markings or features of shelving unit 820 can be used, whether or not the markings are specifically designed for that purpose.

As discussed previously, a mobile device can be used to capture an image of the shelving unit 820. The mobile device (or any other device) can use the image to determine whether the products 828 are positioned properly based on the apertures 836. Alternatively, a fixed camera system can be used to capture an image of shelving unit 1008 and make this determination.

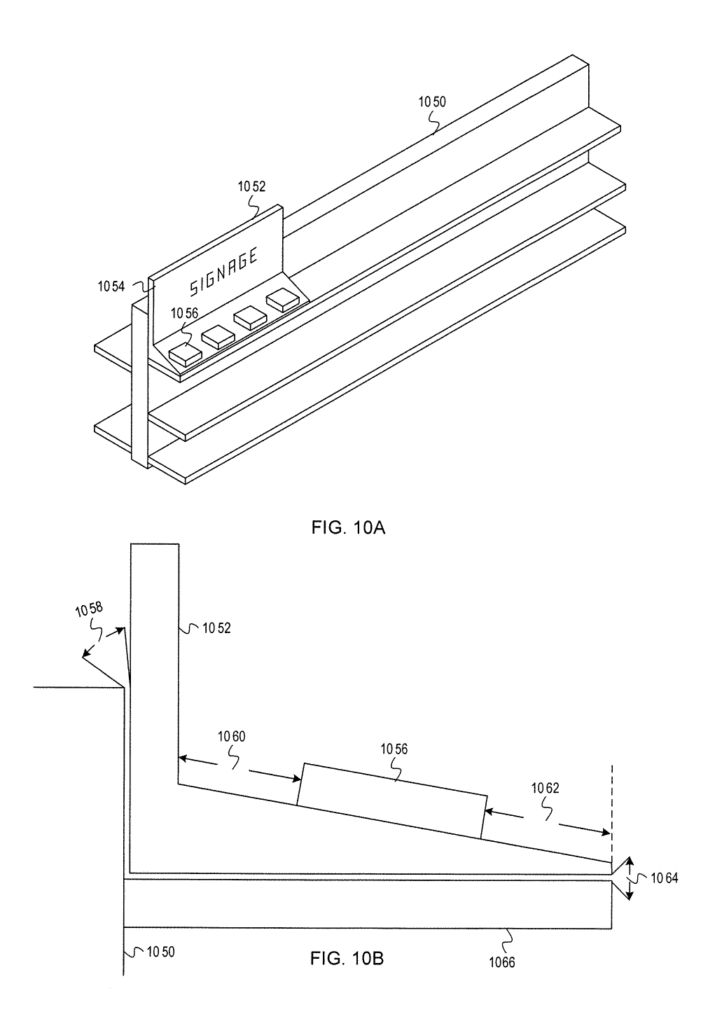

FIG. 9 depicts a pallet-type display 938 upon which compliance checks can be performed, according to some embodiments of the inventive subject matter. In some embodiments, the pallet display 938 may be provided to retailers fully assembled on a pallet 948 or requiring minor assembly such as folding out sections 942 (as depicted by arrows 940 to form shelves similar to shelves 944). Embodiments of the inventive subject matter can be used to determine compliance of the pallet display 938 by capturing images of the pallet display 938 and performing image analysis. For example, a captured image of the pallet 938 can be compared to a representation, such as a photograph or planogram of a correctly assembled pallet display. Additionally, or alternatively, areas surrounding the pallet display 938 can be analyzed. For example, flooring beneath the pallet display can be analyzed to determine if the pallet display 938 has been properly placed. For example, the floor can include markers and a location of the pallet display 938 can be determined based on the markings. Additionally, a type of the flooring can be analyzed to determine if the pallet display 938 has been properly placed. For example, if the pallet display 938 is located on an unfinished floor, such as sealed concrete, this may indicate that the pallet display is located in a warehouse or stockroom as opposed to a sales floor.

In addition to placement of the pallet display 938, products 946 presented on the pallet display can be analyzed for compliance as well as configuration and/or assembly of the pallet display. For example, the captured image of the pallet display 938 can be analyzed to determine if the products 946 are the products intended to be displayed on the pallet display 938.

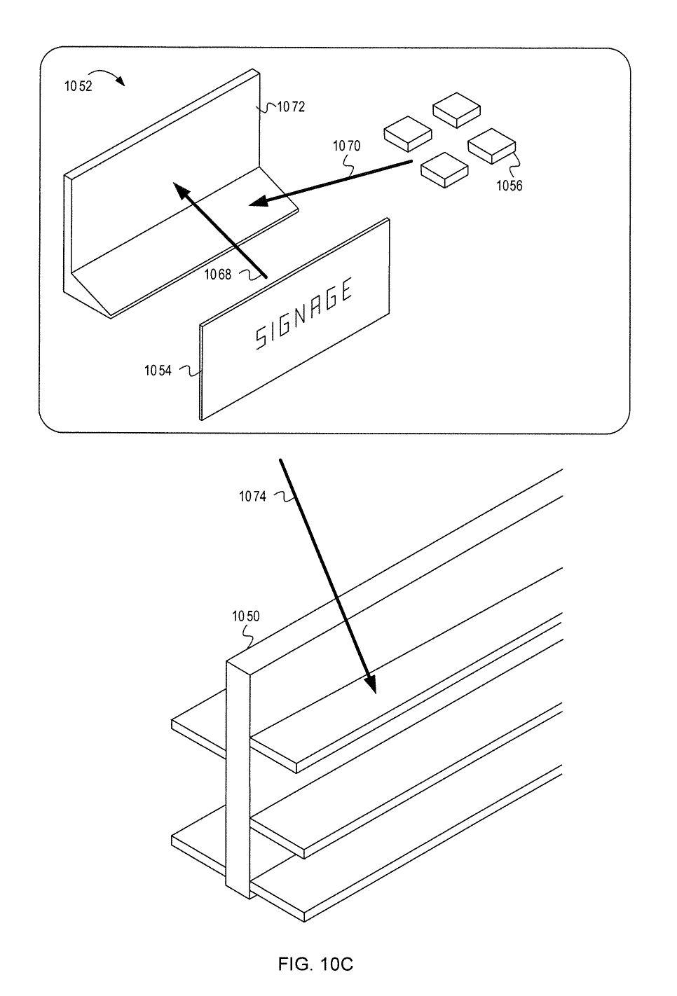

FIG. 10A depicts a display 1052 supported by a shelving unit 1050. The display 1052 is similar to the configured display of FIG. 10C including products 1056 and signage 1054. FIG. 10B depicts a display 1052 supported by a shelf 1066 of the shelving unit 1050 and some example placement errors of the display 1052, according to some embodiments of the inventive subject matter. For example, the display 1052 may overhang the shelf 1066, an edge of the display 1052 may not be in line with an edge of the shelf 1066, the display may not be centered on the shelf 1066, etc. Two example placement errors are depicted in FIG. 10B and indicated by gaps 1058 and 1064. Gap 1058 may result when the display 1052 is not placed against a rear wall of the shelving unit 1050. Gap 1064 may result when the shelf 1066 is not a flat surface. These placement errors (i.e., lack of compliance) can be determined using the methods and systems described herein. For example, a mobile device can be used to capture an image of the display 1052 as well as the surrounding environment (e.g., the shelving unit 1050). Other placement errors can also be detected using such systems. For example, an image captured by a mobile device or closed circuit television system can be analyzed to determine if the products 1056 are placed correctly on the display 1052. For example, a mobile device or backend server can determine if the spacing 1060 and 1062 are appropriate.

FIG. 10C depicts configuration of a display 1052 that is supported by a shelving unit 1050 upon which compliance checks can be performed, according to some embodiments of the inventive subject matter. The display 1052 includes a base 1072, products 1056, and signage 1054. The signage 1054 is affixed to the base 1072, as indicated by arrow 1068 and the products 1056 are arranged on the base 1072, as depicted by arrow 1070. Once configured, a shelving unit 1050 is used to support the display 1052, as indicated by arrow 1074. Once on the shelving unit 1050, the methods, systems, and apparatuses described herein can be used to perform compliance checks on the display 1052, as described above in FIGS. 10A and 10B and the associated text.

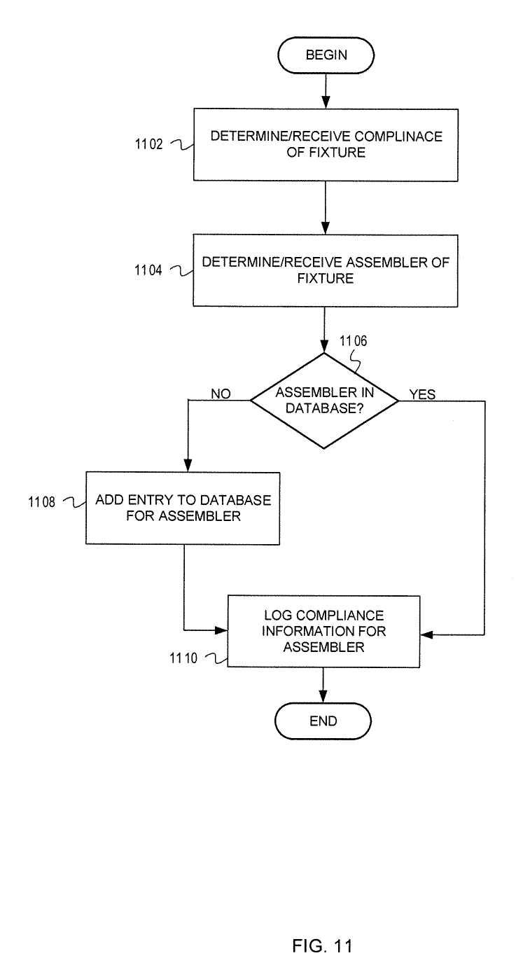

While FIGS. 8-10 and the associated text describe using embodiments of the inventive subject matter to determine and/or verify if/that a product display has been arranged and located properly, FIGS. 11-15 and the associated text describe systems and methods for tracking and/or compiling compliance data. As previously discussed, after compliance is determined, embodiments of the inventive subject matter track and/or store information relating to the compliance data. Scores or other metrics for different installers, assemblers, and/or entities responsible for stocking a retail environment can be calculated and compiled. For example, scores or metrics can indicate time for installation/assembly of a fixture or display for each assembler, the number of fixtures assembled and displays configured per day (or any other time period) for each assembler, the accuracy with which each assembler assembles fixtures and configures displays, and any other suitable metric. Access to this information can be granted, sold, etc. to other parties. Additionally, this information can be used to recommend assemblers and installers. Although the discussion of FIGS. 11-15 refers to tracking information regarding the assembly of fixtures, similar example operations also apply to tracking information regarding correctness of a product display (e.g., grocery items on a shelving unit, electronics in an electronics retailer, inventory in a warehouse, etc.), placement of signage, positioning of displays, and date and/or time at which displays are presented within a retail environment. Additionally, although the discussion of FIGS. 11-15 may refer to either a thick client embodiment or a thin client embodiment, both thick and thin client embodiments are contemplated by the example operations and while the operations remain similar, the device performing the operation may change (e.g., in a thick client embodiment a mobile device may determine an assembler responsible for assembling a fixture while in a thin client embodiment a backend server may make this determination).

FIG. 11 is a flow chart depicting example operations for tracking compliance information for assemblers, according to some embodiments of the inventive subject matter. The flow beings at block 1102.

At block 1102, compliance information for a fixture is determined or received. For example, a backend server can determine compliance of a fixture or receive compliance information for a fixture. Likewise, a mobile device can determine compliance of a fixture. The flow continues at block 1104.

At block 1104, the assembler responsible for assembling a fixture is determined or received. This operation can be performed by either a mobile device or a backend server. In one embodiment, the assembler responsible for assembling a fixture can be determined or deduced based on other information, such as location of the fixture, date and or time that compliance was determined, type of fixture, etc. In other embodiments, fixture information associated with a fixture (e.g., a barcode or alphanumeric code) can include this information. The flow continues at decision diamond 1106.

At decision diamond 1106, it is determined whether the assembler is included in a database or other data structure. For example, a database can be used which includes entries for each assembler. When new compliance data is received, that compliance data can be added to the entry associated with the assembler. If the assembler is not in the database, the flow continues at block 1108. If the assembler is in the database, the flow continues at block 1110.

At block 1108, an entry is added to the database for the assembler. The flow continues at block 1110.

At block 1110, the compliance information is logged for the assembler.

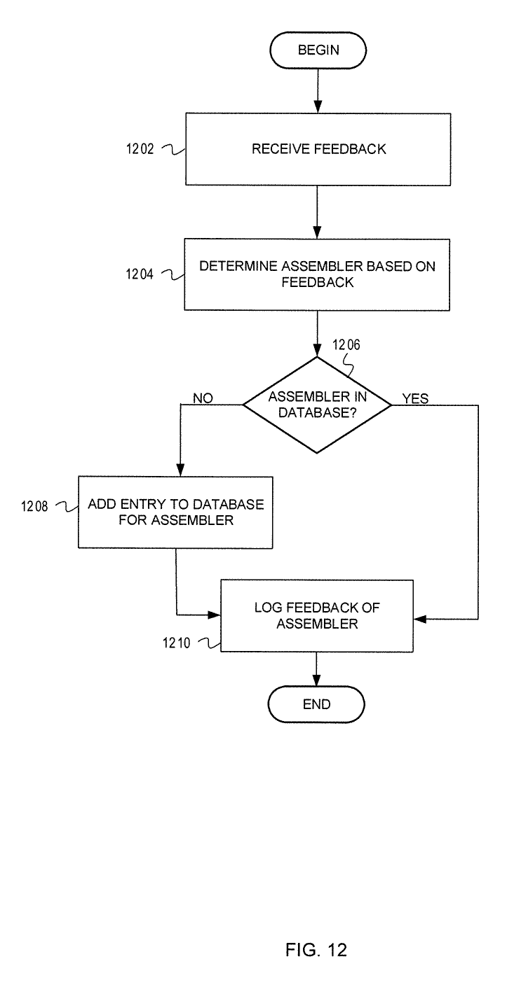

FIG. 12 is a flow chart depicting example operations for tracking feedback information for assemblers, according to some embodiments of the inventive subject matter. In FIG. 11, the compliance information is compiled from compliance checks performed by some embodiments of the inventive subject matter. In FIG. 12, feedback regarding the performance of an assembler is received and compiled. For example, a retailer could provide feedback (e.g., via an online survey, a phone survey, a mailed questionnaire, etc.) regarding an assembler that had assembled a fixture at his/her retail establishment. The flow begins at block 1202.

At block 1202, feedback is received. For example, the feedback can be received via an online survey. A retailer, customer, manager, etc. can visit a website and provide information regarding an assembler or a fixture. The flow continues at block 1204.

At block 1204, the assembler is determined based on the feedback. For example, the assembler can be deduced based on information about the fixture, a time and location of the fixture, the type of fixture, etc. Alternatively, a person providing the feedback can indicate the assembler by entering the assembler or selecting the assembler from a list or menu. The flow continues at decision diamond 1206.

At decision diamond 1206, it is determined whether the assembler is included in a database or other data structure. For example, a database can be used which includes entries for each assembler. When new feedback is received, that feedback can be added to the entry associated with the assembler. If the assembler is not in the database, the flow continues at block 1408. If the assembler is in the database, the flow continues at block 1210.

At block 1208, an entry is added to the database for the assembler. The flow continues at block 1210.

At block 1210, the feedback is logged for the assembler.

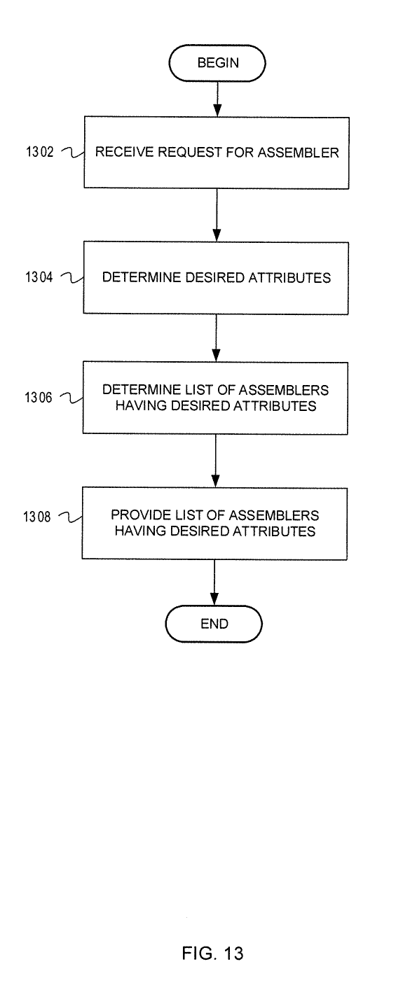

FIG. 13 is a flow chart depicting example operations for providing a list of assemblers in response to a request, according to some embodiments of the inventive subject matter. While FIGS. 11-12 and the associated text describe compiling information about assemblers, FIG. 13 and the associated text describe uses for the information. In one form, the database can be used to recommend assemblers. For example, a retailer may wish to have an assembler with a certain compliance rating, time per fixture, rating etc. assemble fixtures in his/her retail establishment. The flow begins at block 1302.

At block 1302, a request is received for recommendation of an assembler. The flow continues at block 1304,

At block 1304, desired attributes are determined. For example, the request may seek an assembler that properly assembles at least 90% of fixtures, assembles fixtures in an average time of less than one hour, and is located in the Midwest. The flow continues at block 1306.

At block 1306, a list of assemblers having the desired attributes is determined. Continuing the example above, a list of all assemblers in the database that have at least a 90% compliance rating, an average assembly time of less than one hour, and are located in Midwest is created. The flow continues at block 1308.

At block 1308, the list of assemblers having the desired attributes is provided.

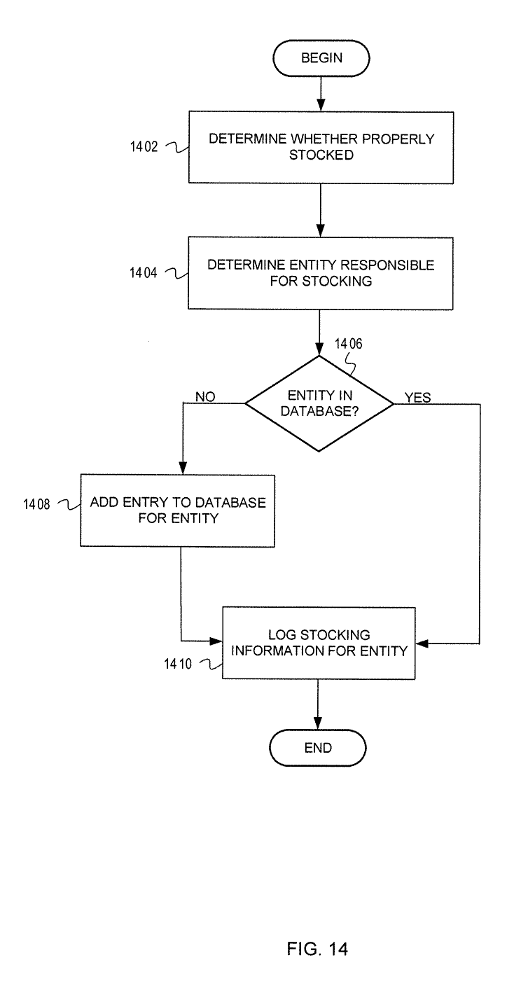

Like previous discussions regarding fixture assembly, similar operations can be performed to determine proper stocking of items in a retail and/or warehouse environment and tracking of information relating to proper stocking. For example, a mobile device (or dedicated image capture device such as one permanently or semi-permanently installed in a retail environment) can capture images of shelves and other display that contain retail products. Image analysis can be performed on the images to determine whether the shelves and other displays are properly stocked. This information can be compiled, stored, and used in manners similar to those described throughout this specification. FIG. 14 is a flow chart depicting example operations for tracking entity stocking information. The flow beings at block 1402.

At block 1402, it is determined whether a display (such as a shelf, a pallet display, etc.) is properly stocked. The flow continues at block 1404.

At block 1404, an entity responsible for stocking the display is determined. This determination can be performed based on deductive reasoning or can be determined based on an explicit input or data provided. The flow continues at decision diamond 1406.

At decision diamond 1406, it is determined whether the entity is included in a database or other data structure. For example, a database can be used which includes entries for each entity. When new feedback is received, that feedback can be added to the entry associated with the entity. If the entity is not in the database, the flow continues at block 1408. If the entity is in the database, the flow continues at block 1410.

At block 1408, an entry is added to the database for the entity. The flow continues at block 1410.

At block 1410, the feedback is logged for the entity.

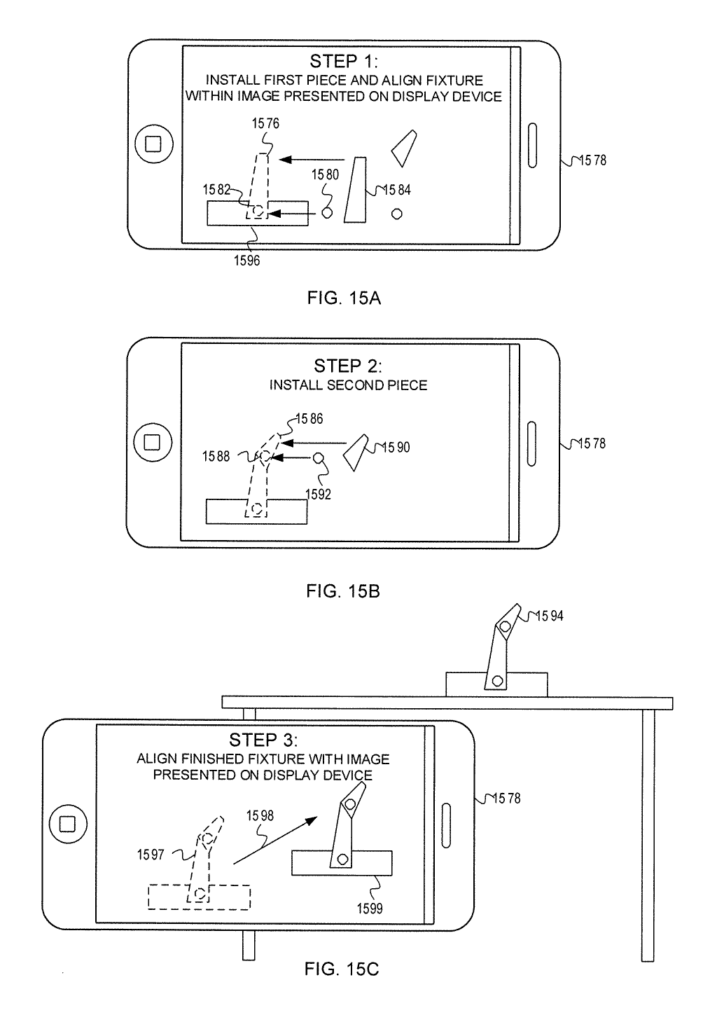

While FIGS. 11-14 and the associated text describe systems and methods for tracking and/or compiling compliance data, FIGS. 15A and 15C depict an embodiment of the inventive subject matter in which a mobile device presents step-by-step directions for fixture assembly.

FIGS. 15A-15C depict an example of providing step-by-step directions for fixture assembly, according to some embodiments of the inventive subject matter. FIG. 15A depicts a first step of three steps to assemble a fixture 1594. A mobile device 1578 presents each step. In some embodiments, the mobile device 1578 includes directions and images for each step. In other embodiments, the mobile device 1578 requests and receives the steps from a backend server. For example, the mobile device 1578 can transmit a request to the backend server that includes an indication of the fixture 1594. The backend server can respond by transmitting the steps to the mobile device 1578.

As depicted in FIGS. 15A-15C, the steps include a graphical representation of the fixture 1594 through various stages of assembly. Such graphical representation can take any suitable form. The steps also include arrows indicating placement of each piece of the fixture 1594. In step 1, the mobile device presents instructions to install a first piece 1584 by attaching first piece 1584 to a base 1596 of the fixture 1594 by fastening the first piece 1584 to the base 1596 using the fastener 1580. This step is depicted by the outline including an outline of the first piece 1576 and an outline of the fastener 1582. After the first step is complete, the user can align the partially assembled fixture with the outline presented on the mobile device. The mobile device (or backend server) can then determine whether the first step has been performed correctly. In some embodiments, this confirmation may not be completed after each step is completed. Rather, this confirmation may be performed after a predetermined number of steps, one or more specific steps, or the assembly is complete.

In FIG. 15B, the mobile device 1578 is presenting the second step. The second step presents instructions to install a second piece 1590 by attaching the second piece 1590 to the first piece 1582 by fastening the second piece 1590 to the first piece 1582 using fastener 1592. The instructions provides an outlines of the second piece 1586 and an outline of the fastener 1588.

In FIG. 15C, the mobile device 1578 is presenting the third step. The third step instructs the assembler to align the completed fixture 1594 with the outline of the completed fixture 1597 presented by the mobile device 1578, as indicated by arrow 1598 and image of completed fixture 1599. Once the assembler has performed this step, a compliance check can be completed.

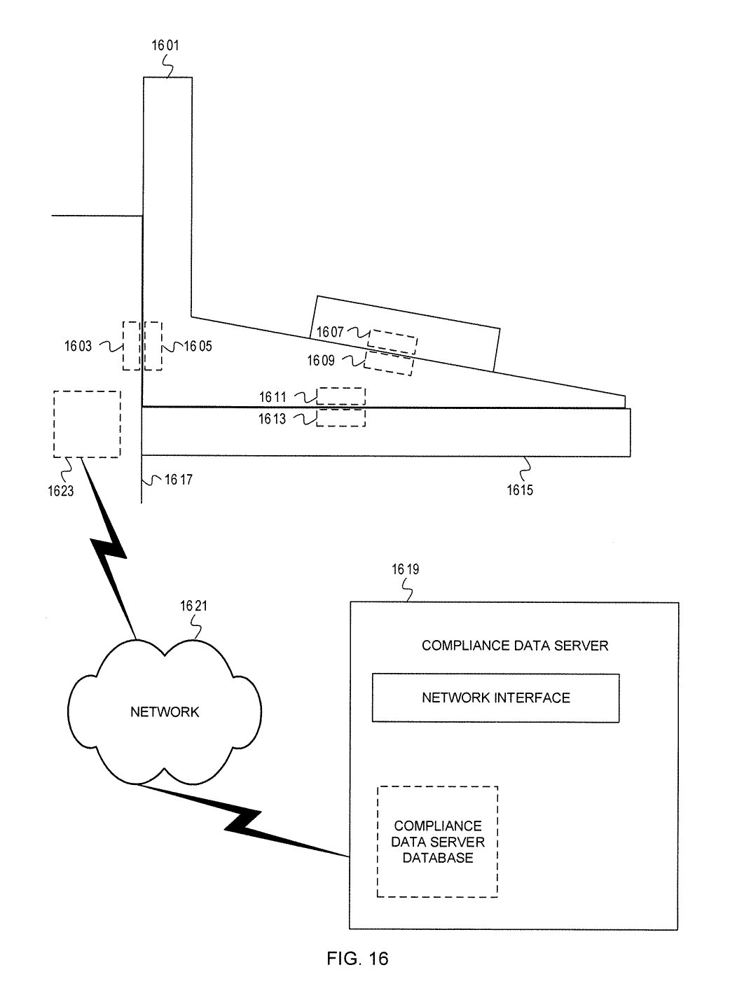

FIGS. 1-15 present many methods, systems, and apparatuses for confirming compliance of a fixture or display primarily utilizing images and images analysis. FIG. 16 and the associated text present a different method for accomplishing similar goals. Specifically, FIG. 16 and the associated text describe accomplishing compliance verification using sensors built in to one or more of displays, shelving units, fixtures, products, etc.

FIG. 16 depicts usage of one or more sensors to determine compliance of a fixture 1601, according to some embodiments of the inventive subject matter. FIG. 16 includes a display 1601 resting on a shelf 1615 of a shelving unit 1617. Any or all of these items can include sensors. Such sensors can be magnetic sensors, optical sensors, current sensors, weight sensors, pressure sensors, proximity sensors, etc. The sensors can detect whether a display is installed or positioned properly. For example, the display 1601 can include a display sensor 1611 and the shelf 1615 can include a shelf sensor 1613. When the display 1601 is properly positioned, the display sensor 1611 and the shelf sensor 1613 can detect this. For example, the display sensor 1611 and the shelf sensor 1613 can be proximity sensors. When the display sensor 1611 and the shelf sensor 1613 are in proximity to each other, the display is correctly positioned. The display sensor 1611 and/or the shelf sensor 1613 can report this information to a controller 1623. The controller can then report this information to a compliance data server 1619 via a network 1621. The compliance data server 1619 can compile and store this information as described in this specification. Similar results can achieved using second display sensor 1605 and shelving unit sensor 1603. Additionally, product placement can be confirmed using a product sensor 1607 and a third display sensor 1609. It should be noted that it may not be necessary to have complimentary sensors (e.g., both display sensor 1611 and shelf sensor 1613 may not be necessary). For example, the shelf sensor 1613 can be an optical sensor and the display 1601 can have a unique marking positioned in-line with the shelf sensor 1613. If the display 1601 is properly positioned on the shelf 1615, the shelf sensor 1613 detects this and reports this information to the controller 1623.

It should be understand that disclosed herein is an apparatus for verifying fixture compliance, the apparatus comprising a receiver configured to receive fixture data, a display device configured to present an image based, at least in part, on the fixture data, an image capture device configured to capture an image of a fixture, and a control circuit configured to compare the image of the fixture and the fixture data.

Further, the control circuit can be further configured to determine compliance of the fixture based on the comparing the image of the fixture and the fixture data.

Further, the receiver can be further configured to receive an indicium of the fixture and receive the fixture data based on the indicium of the fixture.

It should be understood that disclosed herein are one or more non-transitory computer-readable storage media having instructions stored therein, which when executed by one or more processors cause the one or more processors to perform operations comprising receiving fixture data, presenting an image based, at least in part, on the fixture data, capturing an image of a fixture, and comparing the image of the fixture and the fixture data.

Further the operations can further comprise determining compliance of the fixture based on the comparing the image of the fixture and the fixture data.

Further, the operations can further comprise receiving an indicium of the fixture and receiving the fixture data based on the indicium of the fixture.

It should be understood that disclosed herein is an apparatus comprising a receiver configured to receive a request for fixture data associated with a fixture, determine, based at least in part, on the request, relevant fixture data, a transmitter configured to transmit the relevant fixture data, the receiver further configured to receive image data, and a control circuit configured to compare the image data and the relevant fixture data.

Further, the control circuit can further be configured to determine compliance of the fixture based on the comparing the image data and the relevant fixture data.

It should be understood that disclosed herein are one or more non-transitory computer-readable storage media having instructions stored therein, which when executed by one or more processors cause the one or more processors to perform operations comprising receiving a request for fixture data associated with a fixture, determining, based at least in part, on the request, relevant fixture data, transmitting the relevant fixture data, receiving image data, and comparing the image data and the relevant fixture data.

Further, the operations can further comprise determining compliance of the fixture based on the comparing the image data and the relevant fixture data.

It should be understood that disclosed herein is an apparatus comprising a control circuit configured to determine information regarding compatibility of a subject fixture, determine an assembler of the subject fixture, in response to a determination that a database does not include an entry for the assembler of the fixture, create, in the database, an entry for the assembler of the fixture and store, in association with the entry for the assembler of the fixture, the information regarding compatibility of the fixture and the assembler of the fixture, and in response to a determination that the database includes the entry for the assembler of the fixture, store, in association with the entry for the assembler of the fixture, the information regarding compatibility of the fixture.

It should be understood that disclosed herein are one or more non-transitory computer-readable storage media having instructions stored therein, which when executed by one or more processors cause the one or more processor to perform operations comprising determining information regarding compatibility of a subject fixture, determining an assembler of the subject fixture, in response to determining that a database does not include an entry for the assembler of the fixture, creating, in the database, an entry for the assembler of the fixture and storing, in association with the entry for the assembler of the fixture, the information regarding compatibility of the fixture and the assembler of the fixture, and in response to determining that the database includes an entry for the assembler of the fixture, storing, in association with the entry for the assembler of the fixture, the information regarding compatibility of the subject fixture.

What is claimed is:

1. A method comprising:
receiving, at a mobile computing device, an indicium of a fixture;
receiving, at the mobile computing device, fixture data based, at least in part, on the indicium of the fixture;
presenting, via a display device of the mobile computing device, a graphical representation of the fixture data;
capturing, via an image capture device of the mobile device, an image of the fixture; and
determining, based, at least in part, on the image of the fixture and the fixture data, compliance of the fixture.

2. The method of claim 1, wherein the determining, based at least in part, on the image of the fixture and the fixture data, compliance of the fixture, comprises comparing the image of the fixture with the graphical representation of the fixture data.

3. The method of claim 1, further comprising:
transmitting, to a compliance data server, the indicium of the fixture, and wherein the fixture data is received from the compliance data server.

4. The method of claim 1, further comprising:
in response to determining that the fixture is compliant, transmitting, to a compliance data server, a notification of compliance; and
in response to determining that the fixture is not compliant, transmitting, to the compliance data server, a notification of noncompliance.

5. The method of claim 1, wherein the determining is based on user input, and further comprising:
in response to receiving positive user input, wherein the positive user input indicates that the fixture is compliant,
determining that the fixture is compliant; and
in response to receiving negative user input, wherein the negative user input indicates that the fixture is noncompliant,
determining that the fixture is noncompliant.

6. The method of claim 1, wherein the receiving, at the mobile device fixture data based, at least in part, on the indicium of the fixture comprises:
searching, by the mobile computing device, a data repository stored on the mobile device for a data structure associated with the indicium of the fixture; and
retrieving, by the mobile computing device, the data structure associated with the indicium of the fixture.

7. The method of claim 1, wherein the receiving the indicium of the fixture includes one of, capturing an image of the indicium of the fixture via the mobile computing device, receiving user input selecting the indicium of the fixture, and receiving user input indicating the indicium of the fixture.

8. The method of claim 1, wherein the indicium of the fixture is indicated by one or more of a barcode, a two-dimensional barcode, a numeric code, an alphanumeric code, an alphabetic code, an RFID tag, and a data transmission to the mobile computing device.

9. A method comprising:
receiving, at a compliance data server via a communications network, a request for fixture data associated with a fixture;
determining, based, at least in part, on the request, relevant fixture data;
transmitting, via the communications network, the relevant fixture data;
receiving, via the communications network, image data;
determining, based on the image data and the relevant fixture data, whether the fixture is compliant.

10. The method of claim 9, wherein the determining whether the fixture is compliant is based on a comparison of the image data to the relevant fixture data.

11. The method of claim 9, wherein the image data includes an image of the fixture.

12. The method of claim 10, further comprising:
determining a position in which the fixture is oriented in the image of the fixture, and
wherein the determining whether the fixture is compliant is based on a comparison of the image of the fixture, the position in which the fixture is oriented in the image of the fixture, and the relevant fixture data.

13. The method of claim 9, further comprising:
for each determination made regarding fixture compliance, determining an assembler of a subject fixture; and
updating a database to include information about compliance of the subject fixture and the assembler of the subject fixture.

14. The method of claim 13, further comprising:
selecting, from the database, one or more assemblers that are consistent with one or more criteria; and
recommending the one or more assemblers.

15. The method of claim 13, further comprising:
providing access to the database to third parties.

16. The method of claim 9, wherein the request for fixture data includes an indicium of the fixture.

17. The method of claim 16, wherein the indicium of the fixture includes one or more of an image of the fixture, an image of a visual code associated with the fixture, a code associated with the fixture, a user selection of the fixture, and information about a location of the fixture.

18. The method of claim 9, wherein the determining whether fixture is compliant includes determining if illumination external to the fixture is compliant.

19. The method of claim 9, wherein the request for fixture data is received from a mobile device and further comprising:
providing, to a user associated with the mobile device, an award.

20. The method of claim 19, further comprising:
determining that the user associated with the mobile device has been provided a threshold number of awards; and
providing, to the user associated with the mobile device, one or more of a monetary prize and non-monetary prize.

21. The method of claim 20, wherein the non-monetary prize is one or more of a coupon, a gift certificate, points, a promotional offer, and a position on a leaderboard.

22. A method comprising:
determining information regarding compatibility of a subject fixture;
determining an assembler of the subject fixture;
in response to determining that a database does not include an entry for the assembler of the fixture,
creating, in the database, an entry for the assembler of the fixture; and
storing, in association with the entry for the assembler of the fixture, the information regarding compatibility of the fixture and the assembler of the fixture;
in response to determining that the database includes the entry for the assembler of the fixture,
storing, in association with the entry for the assembler of the fixture, the information regarding compatibility of the subject fixture.

23. The method of claim 22, further comprising
receiving a request to provide assemblers;
determining, based at least in part on the request to provide assemblers, desired attributes;
generating, from the database, a list of assemblers that are consistent with the desired attributes; and
providing the list of assemblers that are consistent with the desired attributes.

24. The method of claim 22, wherein the desired attributes include one or more of a compliance metric, a timeliness metric, and a tolerance metric.

25. The method of claim 22, further comprising:
providing third party access to the database.

26. The method of claim 25, wherein the third party access is based on one or more of a subscription access plan, a payment access plan, and an unpaid access plan.

27. A method comprising:
determining, by a mobile computing device, an indicium of a fixture;
receiving, at the mobile computing device, fixture assembly instructions based, at least in part, on the indicium of the fixture; and
presenting, via a display device of the mobile computing device, a graphical representation of a first step of the assembly instructions.

28. The method of claim 27, further comprising:
presenting, via the display device, a graphical representation of a second step of the assembly instructions.

29. The method of claim 27, further comprising:
capturing, via an image capture device of the mobile device after the first step of the assembly instructions is complete, an image of the fixture; and
determining, based on the fixture assembly instructions and the image of the fixture, that the first step of the assembly instructions is complete.

30. The method of claim 29, further comprising:
after determining that the first step of the assembly instructions is complete, presenting, via the display device, a second step of the assembly instructions.

31. The method of claim 27, further comprising:
transmitting, to a compliance data server, the indicium of the fixture, and wherein the fixture assembly instructions are received from the compliance data server.

32. The method of claim 27, wherein the receiving the indicium of the fixture includes one of, capturing an image of the indicium of the fixture via the mobile computing device, receiving user input selecting the indicium of the fixture, and receiving user input indicating the indicium of the fixture.
